(19) United States
(12) Patent Application Publication
(10) Pub. No.: US 2023/0359347 A1
(43) Pub. Date: Nov. 9, 2023

(54) SYSTEMS AND METHODS FOR NAVIGATING INTERACTIVE ELEMENTS OF AN APPLICATION

(71) Applicant: SB22, Inc., Dallas, TX (US)

(72) Inventor: Vladimir Jovanovic, Belgrade (RS)

(21) Appl. No.: 18/314,375

(22) Filed: May 9, 2023

Related U.S. Application Data
(60) Provisional application No. 63/364,386, filed on May 9, 2022.

(51) Int. Cl. G06F 3/0488; G06F 3/0485; G07F 17/32

(52) U.S. Cl. CPC G06F 3/0488; G06F 3/0485; G07F 17/3209; G07F 17/3211; G07F 17/3288

(57) ABSTRACT

Aspects of the present disclosure relate to a focus mode which allows a user to navigate events on an application and engage with interactive elements associated with the event. The focus mode condenses the event offerings presented in an application to one or more event categories with a single event displayed at a time for the selected category. The user may then navigate through event cards within the event category and interactive elements associated with the event by providing various gesture inputs. Ultimately, the focus mode provides a simplified interface that prioritizes the interactive elements available for a selected event to generate and maintain user interest in the event.

### CROSS-REFERENCE TO RELATED APPLICATION

This application claims priority to U.S. Provisional Application No. 63/364,386, titled “SYSTEMS AND METHODS FOR THE GENERATION OF GAMING OPPORTUNITIES FOR DISPLAY ON DEVICES HAVING DIFFERING FORM FACTORS” filed on May 9, 2022, the entire disclosure of which is hereby incorporated by reference in its entirety.

### BACKGROUND

Recently, the quantity and type of entertainment options available to the public has expanded dramatically. Users have options to view and participate in traditional events such as concerts and live sports as well as newer events such as video games and streaming video platforms among many others. However, with the increasing number of events and interactive elements it has become difficult for users to navigate through each offering and identify the events and interactive elements associated with an event they are actually interested in. The process of navigating from one screen to another to find events and select interactive elements on a device is a time-consuming and confusing process which often leaves users frustrated by the experience.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to a focus mode which allows a user to navigate events on an application and engage with interactive elements associated with the event. The focus mode condenses the event offerings presented in an application to one or more event categories with a single event displayed at a time for the selected category. The user may then navigate through event cards within the event category and interactive elements associated with the event by providing various gesture inputs (swipe left, swipe right, swipe up, swipe down, tap and hold, etc.). The user may then select one or more interactive elements from a single screen of the application rather than navigating through multiple pages to view and select various interactive elements. Ultimately, the focus mode provides a simplified interface that prioritizes the interactive elements available for a selected event to generate and maintain user interest in the event.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary system for presenting events and interactive elements in a focus mode, according to aspects described herein.

FIG. 2 depicts an exemplary user interface for an application with one or more event categories, event cards, and interactive elements, according to aspects described herein.

FIG. 3 depicts an exemplary user interface for an application in focus mode, according to aspects described herein.

FIG. 4 depicts an exemplary user interface for an application in focus mode with a date selection feature, according to aspects described herein.

FIG. 5 depicts an exemplary user interface for confirming a selection of an interactive element via gesture input while using the focus mode of an application, according to aspects described herein.

FIG. 6 depicts an exemplary confirmation notification for an application in focus mode, according to aspects described herein.

FIG. 7 is a block diagram illustrating a method of providing a focus mode for an application, according to aspects described herein.

FIG. 8 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Existing event platforms (e.g., websites, applications, etc.) present interactive elements associated with the event in a way that is complicated for users to navigate quickly and easily. For example, existing applications tend to rely on large tables of event data displaying available interactive elements to the users in a complex visual requiring skill to comprehend. Given the significant amount of information that may be associated with each event and associated interactive elements (e.g., available tickets, merchandise options, NFT options, betting odds, available payouts, terms, etc.,) the result is a cluttered interface with multiple screens that makes it difficult for users to identify desired interactive elements. Furthermore, existing solutions generally use standard navigational tools, such as drop-down menus, to help organize the large amounts of information associated with the events and interactive elements. While said solutions are easy to navigate using a mouse and keyboard, these navigational tools are not as easily operable when using a mobile device, wearable device, and/or virtual reality device. Ultimately, the complex interface often results in frustrated users who are unable to locate and view in each offered interactive element for a given event.

To address these identified issues, aspects of the present disclosure relate to a focus mode user interface which organizes event information in a way which allows users to easily navigate the vast amounts of information available on an application or website to quickly find events and interact with interactive elements using gesture input on a touch screen interface. The focus mode user interface organizes event information such that each screen displayed by a user interface includes all interactive elements for an event. As used herein, an event card refers to a user interface that organizes and depicts each available interactive element for a specific event in the focus mode interface. As used herein, an interactive element is any selectable aspect related to the event which is offered to the user. For example, if the event is a basketball game the interactive elements may include options to purchase tickets, view, and place one or more bets, purchase merchandise, bid on an in-game non-fungible token (NFT), etc. As another example, if the event is a music concert, the interactive elements may include options to purchase tickets, to stream the concert live, to purchase merchandise, to buy an opportunity to interact with the artist, etc.

The user can navigate to the focus mode interface and cycle through different event cards, different event categories, and associated interactive elements via gesture input on the touch screen of the user device. As described below, each time a user swipes the screen in a various direction (e.g., up, down, left, right), the user interface will modify the display accordingly to provide a different event category, event card, and/or additional interactive elements. To select an interactive element the user may provide a gesture input of tapping the interactive element on the touch screen. Whereas tapping and holding the interactive element will confirm a selection (e.g., purchase, place a bet, etc.) and trigger a confirmation screen.

Focus mode provides several benefits to the user. One benefit is that focus mode presents the plurality of interactive elements associated with an event on a single user interface for easy identification and access by the user. Further, focus modes provides benefits to producers of events and interactive elements by combining the numerous offerings into a single user interface, thereby increasing the traffic for all producers, especially those with relatively niche products. Ultimately, the focus mode improves the users experience and enjoyment of their selected event by making it easier for the user to engage with every aspect of the event from both a live and virtual environment.

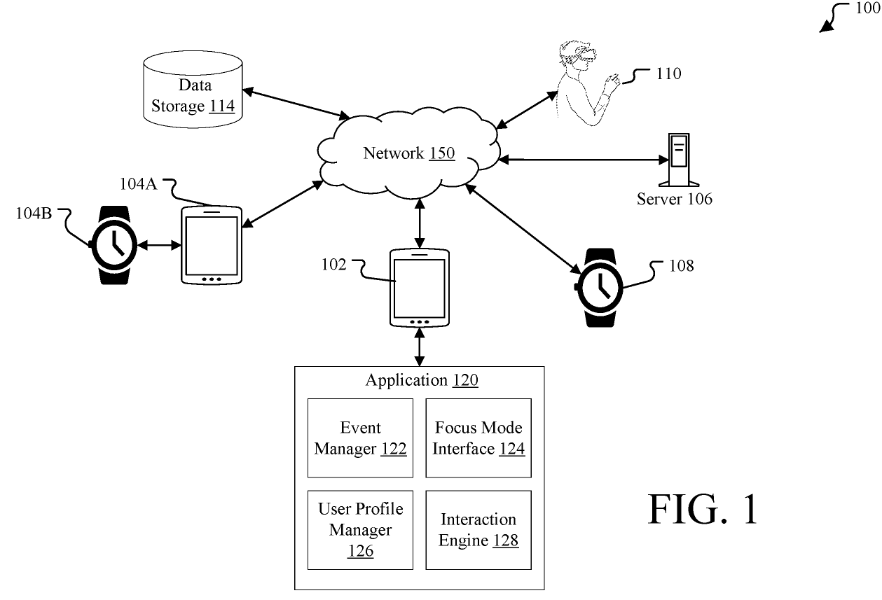

FIG. 1 depicts an exemplary system for presenting events and interactive elements in a focus mode, according to aspects described herein. System 100 includes several configurations for accessing an application 120, including a mobile device 102, a smartwatch 104B securely connected to a mobile device 104A, a smartwatch 108, and a virtual reality device 110, in addition to server 106, and data storage 114. Each of the mobile device 102, smartwatch 104B, mobile device 104A, smartwatch 108, virtual reality device 110, server 106, and data storage 114 may be connected via a network 150 via a Wi-Fi connection or a cellular data connection. Although the exemplary wearable devices 104B and 108 are depicted as smartwatches, one of skill in the art will appreciate that other types of wearable devices may be employed by system 100 without departing from the scope of this disclosure. Network 150 may be any type of network, such as, for example, a LAN, a WAN, a near-field communications network, a cellular broadband network, point-to-point network, a Wi-Fi network, enterprise network, the Internet, etc. and may include one or more of wired, wireless, and/or optical portions.

Each of the mobile device 102, smartwatch 104B, mobile device 104A, smartwatch 108, and virtual reality device 110 may include an application 120 including an event manager 122, focus mode interface 124, user profile manager 126, and interaction engine 128. A user may access the application 120 and be presented with one or more user interfaces for viewing events and interactive elements formatted for the appropriate device format based on how the user is accessing the focus mode. The event manager 122 may be utilized to coordinate the events, event categories, and interactive elements associated with an event that are displayed to the user. In this context an event is the occurrence of some thing that the user may want to participate in via the one or more interactive elements. Event participation may occur either virtually or via live interaction. Thus, an event may be a plurality of things from traditional events like a sporting event (e.g., football game, basketball game, golf, hockey, racing, etc.), a concert, theater performance, movie, TV show, etc. to a video game, live-streamed gaming competition, conferences, etc.

Event categories are utilized by the event manager 122 to organize the plurality of events that may be available so that events can be presented to a user in an ordered way. For example, one event category could be sports and include a list of sports leagues, upcoming games, and even non-game sports related events (e.g., rookie draft, combine activities, sports related TV shows and documentaries, etc.). Another event category may be music and include upcoming concerts, different musical genres, etc. A gaming event category could include specific video games with options to view other players, live video streaming options, competitive game competitions, etc.

Each event and event category may have one or more interactive elements associated with it which the user can select via gesture input on the touchscreen of the mobile devices 102 and 104A and/or the smart watches 104B and 108 or by gesture capture by the virtual reality device 110. The events and each interactive element associated with the event are organized into one or more event cards which by the event manager 122. An interactive element is any selectable aspect related to the event which is offered to the user. Examples of interactive elements may be things commonly associated with an event. For example, if the event is a college football game interactive elements may include betting opportunities, option to buy ticket, viewing options for the game, and merchandise (e.g., jerseys, team gear, branded footballs, etc.). However, the interactive elements are not limited and could include things like an option to purchase music associated with the game (e.g., college fight songs, a recording of the national anthem or halftime show, etc.) as well as NFTs of in-game highlights, among others.

The interaction engine 128 manages the interactive elements for the event and event categories and processes received gesture inputs. The gesture inputs may be received by touch screens on the mobile devices 102 and 104A and/or the smart watches 104B and 108 based on the configuration utilized by the user. With a horizontal swipe (e.g., the user swipes left or right) the focus mode user interface transitions between event categories. For example, a left or right swipe might transition between different sports leagues (e.g., NFL, NBA, NHL, Premier League, etc.) as separate event categories or different event types from a broader context (e.g., music, e-sports, theater, etc.). The transition between event categories causes a separate user interface for the event category with a specific event to be displayed in the focus mode. Once in the new event category, users can navigate to different events in the same event category (e.g., a specific basketball game, concert, e-sport match, etc.) with a vertical swipe (e.g., swiping up or down) on the touch screen. The user may scroll through interactive elements on an event card via a drag gesture on the touchscreen (e.g., the user drags their finger up or down on the touch screen). To select an event category, event card, and/or an interactive element, the user may provide a gesture input of tapping the interactive element on the touch screen. Whereas tapping and holding the interactive element will confirm a selection (e.g., purchase, place a bet, etc.) and trigger a confirmation screen.

In some examples, if a user swipes to the end of the available event cards for that date or time range, the interaction engine 128 may prompt the user to modify the date or time range for the event to via a separate interface. Selecting a different date or time allows the user to view event cards for future events and select interactive elements which can be purchased or saved in the user profile by the user profile manager 126 for later confirmation. The user profile manager 126 manages the user profile, user preferences, payment options, saves interactive elements, records purchase history, as well as saving interactive elements obtained by the user which may be accessed later (e.g., NFTs, music, etc.).

Server 106 is operable to connect to any number of devices (e.g., mobile devices 102 and 104A, smartwatches 104B and 108, virtual reality device 110) and to provide information about available events and receive requests to interact with interactive elements from such devices. Server 106 is further operable to connect to data storage 114 which stores information about current, future, or past events and event categories, information utilized by the user profile manager 126 relating to user accounts, information about various interactive elements, and the like. Data storage 114 may be updated in real-time to update interactive elements (e.g., modify ticket and/or seat availability for an event, update odds for existing bets, include new bets for an event (e.g., a sporting event, an e-sport event, etc.) and/or other types of interactive elements as an event progresses. Example interactive elements may be live bets such as whether a player makes his next free throw, whether the next play results in a first down, whether a goal is scored in the next 5 minutes, etc. Server 106 accesses the data storage 114 to retrieve information about an event and/or available interactive elements in response to a request from a device (e.g., mobile devices 102 and 104A, smartwatches 104B and 108, virtual reality device 110). Exemplary devices are operable to receive the event category, event card, and/or interactive element information from the server 106 in response to a request from the device and display the received event category, event card, and/or interactive element information in a format suitable for the device. For example, the server 106 may determine that the request for the event category, event card, and/or interactive element information originated from a wearable device 108 and format the data accordingly prior to delivering the information to the requesting wearable device.

Although specific types of wearable devices have been depicted as part of system 100, one of skill in the art will appreciate that different types of wearable devices may be employed by the system 100 without departing from the scope of this disclosure. Further, while specific types of user interfaces (e.g., displays) and user interface controls (e.g., gesture control, crown control, etc.) have been described, one of skill in the art will appreciate that other types of controls or user interfaces may be employed by the system 100 without departing from the scope of this disclosure. For example, an audio and speech interface may be employed and/or a haptic feedback interface may be employed in addition to, or in place of, the user interface flow depicted in FIG. 1 without departing from the scope of this disclosure.

Mobile devices 102 and 104A, smartwatches 104B and 108, and virtual reality device 110 may be configured to execute one or more applications and/or services and/or manage hardware resources (e.g., processors, memory, etc.), which may be utilized by users of the devices. The mobile devices 102 and 104A, smartwatches 104B and 108, and virtual reality device 110 can send and receive content data as input or output which may be, for example from a microphone, an image capture device (e.g., a camera), a global positioning system (GPS), etc., that transmits content data, a computer-executed program that generates content data, and/or memory with data stored therein corresponding to content data. The content data may include visual content data, audio content data (e.g., speech or ambient noise), a viewer-input, such as a voice query, text query, etc., an image, an action performed by a viewer and/or a device, a computer command, a programmatic evaluation gaze content data, calendar entries, emails, document data (e.g., a virtual document), weather data, news data, blog data, encyclopedia data and/or other types of private and/or public data that may be recognized by those of ordinary skill in the art. In some examples, the content data may include text, source code, commands, skills, or programmatic evaluations.

Mobile devices 102 and 104A, smartwatches 104B and 108, and virtual reality device 110 may each include at least one processor, such as interaction engine 128, that executes software and/or firmware stored in memory. The software/firmware code contains instructions that, when executed by the processor causes control logic to perform the functions described herein. The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the examples, various logic may be implemented in any appropriate fashion and would remain in accordance with the examples herein disclosed

In accordance with some aspects, data storage 114 may be a network server, cloud server, network attached storage (“NAS”) device, or another suitable computing device. Data storage 114 may include one or more of any types of storage mechanism or memory, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. Although only one instance of the data storage 114 is shown in FIG. 1, the system 100 may include two, three, or more similar instances of the data storage 114. Moreover, the network 150 may provide access to other data stores similar to data storage 114 that are located outside of the system 100, in some examples.

In some examples, the network 150 can be any suitable communication network or combination of communication networks. For example, network 150 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, network 150 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

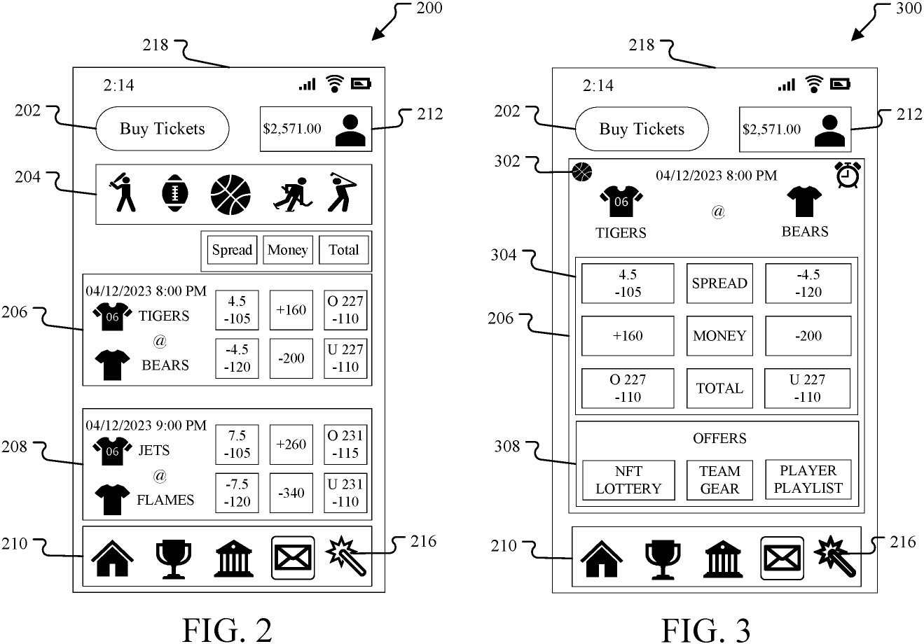

FIG. 2 depicts an exemplary user interface for an application with one or more event categories, event cards, and interactive elements, according to aspects described herein. As displayed, interface 218 may be formatted and displayed for any of mobile devices 102 and 104A, smartwatches 104B and 108, and virtual reality device 110. As shown in FIG. 2, display 218 is formatted for a mobile device and includes a plurality of interactive elements. As shown in FIG. 2 the focus mode has not been selected yet. Thus, the interactive elements are not limited to a single event card, such as event cards 206 or 208, and the event categories 204 are displayed as a banner on top of the event cards. There may be an interactive element 202 offering tickets for sale as well as user icon 212 which includes a user profile picture which may be a selectable link to the user profile. In some examples, user icon 212 may include a cash balance for the user profile, in this case $2,571.00.00. As evidenced by interface 218, the display is congested with a large volume of unrelated information that doesn’t necessarily relate to events and interactive elements which the user is interested in. At the bottom of interface 218 is menu options 210 which among other menu options includes a focus mode 216 which is selectable by the user via a tap gesture input. When selected the focus mode 306 will be displayed on interface 218 as shown in FIG. 3. In some examples, focus mode may be the default viewing mode for interface 218. In other examples, viewing modes other than focus mode may not be offered for display on interface 218.

As shown in FIG. 3 the focus mode 306 includes a single event card for an event category. The event card to display when entering focus mode or transitioning event categories may be initially selected based upon application history (e.g., what the user has recently been viewing, or what other users are viewing) and/or one or more user preferences from the user profile 212. In this case an event card 206 for a basketball game between the Tigers and Bears is displayed because of a user preference for the Tigers. The event information such as the date and time of the event may be displayed on the event card 206. The event category, in this case basketball, may be shown via an icon 302 such as a basketball in the upper left corner of the event card 206. As described previously the event card 206 may contain a plurality of interactive elements associated with the event. In this example, the event card 206 is for a basketball game so the interactive element 304 includes one or more betting opportunities such as the spread, money line, and total for each team along with the information about the bet such as the spread amount, 4.5, and the odds for each team. Interactive element 308 includes non-betting offers associated with the event such as an NFT lottery for an NFT that will be created based on a play from the game, team gear that can be purchased, as well as a player curated music playlist. As described above, if the user wants to view additional interactive elements associated with the event, they may provide a drag gesture input and scroll through other available interactive elements. To change event card within the same event category the user may provide a vertical swipe gesture input, as described above. The buy tickets interactive element 202, user icon 212, and menu options 210 may be included in the focus mode as well.

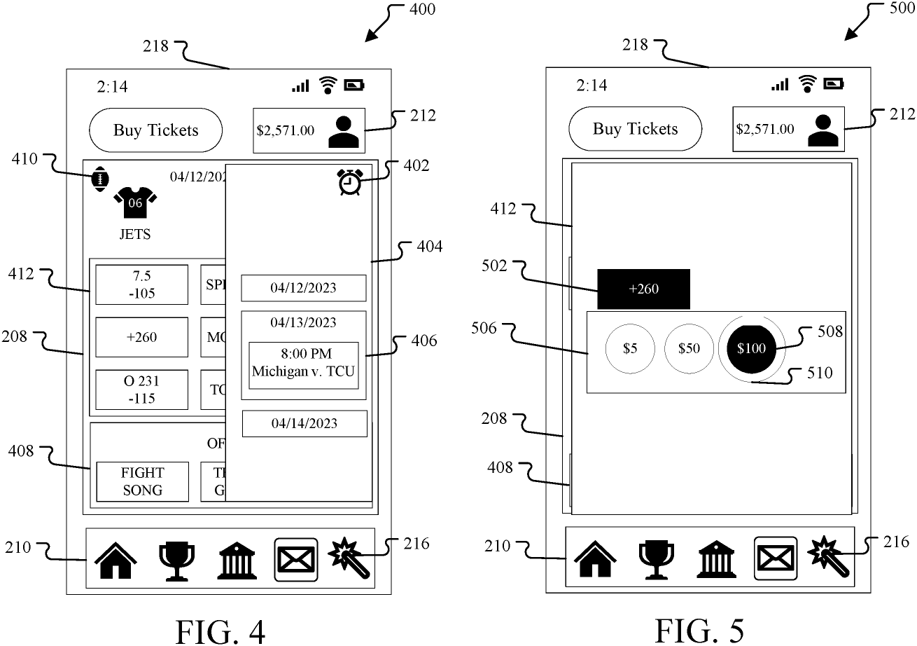

FIG. 4 depicts an exemplary user interface for an application in focus mode with a date selection feature, according to aspects described herein. In FIG. 4 the user has provided a horizontal gesture input to change the event category to college football as evidenced by the football icon 410 in the upper corner of the event card 208. The interactive elements have changed based on the new event with interactive element 412 pertaining to a new set of betting opportunities while interactive element 408 includes other offers such as a recording of the college fight song among others. In this case, the user wants to select a different date to view a different game, so they have provided a tap gesture input on date selection icon 402, which opens a window 404 on the display 218 showing other date options for the event category, in this case college football. In this case, another event option is available and presented on interactive element 406 which the user may select via a tap gesture input on interactive element 406. To close the date selection icon 402 the user may provide another tap gesture input.

FIG. 5 depicts an exemplary user interface for confirming a selection of an interactive element via gesture input while using the focus mode of an application, according to aspects described herein. In FIG. 5 the user has decided to place a bet on the money line by providing a confirming input of tapping and holding interactive element 502. In some examples the interactive element may be highlighted in some way to emphasize the user’s selection, in the present example the other interactive elements 408 and 412 are whited out and a confirmation screen 506 is displayed on display 218. In this case, because the interactive element 502 is a betting option the user is offered one or more bet amounts $5, $50, and $100 on confirmation screen 506. In some examples, the system may standardize the interactive elements presented, such as the bet amounts for a bet based on user preferences, user history, and a user risk profile. The user risk profile may be developed using one or more aspects of artificial intelligence and machine learning to identify a risk level associated with the user. The system may be able to predict preferred bet amounts for a certain event and/or event category based on the user risk profile.

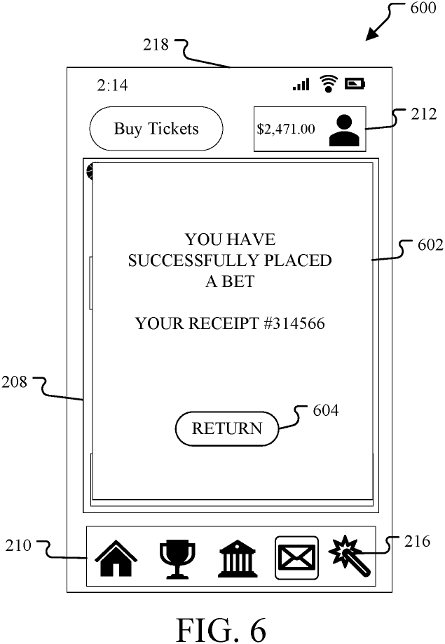

In this case, the user provides a tap and hold gesture input on the $100 icon 508. The tap and hold gesture are a confirming input that initiates a confirmation sequence where the icon 508 is highlighted and a timer ring 510 proceeds around the outside circumference of the icon 508. The user needs to hold the icon 508 until the timer ring 510 closes to confirm the bet and transition to the confirmation screen of FIG. 6. In other examples, there may not be a timer ring 510 as a visual indicator but an internal timer value for the press and hold that once completed by the user transitions the display 218 to the confirmation page of FIG. 6. In other examples, the confirming input may be a rotational input of a rotational element of a device such as a smart watch which has a rotational element. In this case, the timer ring 510 may be a rotation ring where the ring closes via rotation of the rotational element and when closed the selection is confirmed. It will be appreciated by one having skill in the art that while a betting opportunity was confirmed if the user had selected a fight song icon in interactive element 408 a similar confirmation sequence would have occurred.

FIG. 6 depicts an exemplary confirmation notification for an application in focus mode, according to aspects described herein. In FIG. 6 the user has completed the confirmation process and placed a bet. A confirmation message 602 may be displayed to the user on display 218 with an option to return to the application for additional events and/or interactive elements. The interactive element confirmed by the user will be saved on the user’s profile and accessible via the user icon 212. Thus, if the user had purchased an NFT, instead of a bet, they could access the NFT via the user icon 212 on their user profile. Additionally, the dollar value displayed on user icon 212 associated with the user profile has decreased by $100 based on the bet being placed providing the user with additional confirmation of the interaction.

It will be appreciated by one having skill in the art that interface 218 and focus mode 306 are exemplary design formats and that many other design formats are possible and anticipated within the scope of this disclosure. Further, although betting opportunities are discussed with respect to FIGS. 2-6 it should be appreciated that the user could have provided a horizontal swipe gesture input to transition to a different event category for a comedy show, browsed available comedy show event cards via a series of vertical swipe gesture inputs, selected an interactive element for a comedy show relating to an NFT of a joke told at the specific comedy show, and confirmed a purchase of that NFT via a similar process described above. It will be appreciated by one having skill in the art, that this is just one example of the plurality of examples described for event categories, event cards, and interactive elements which may be accessed via a focus mode.

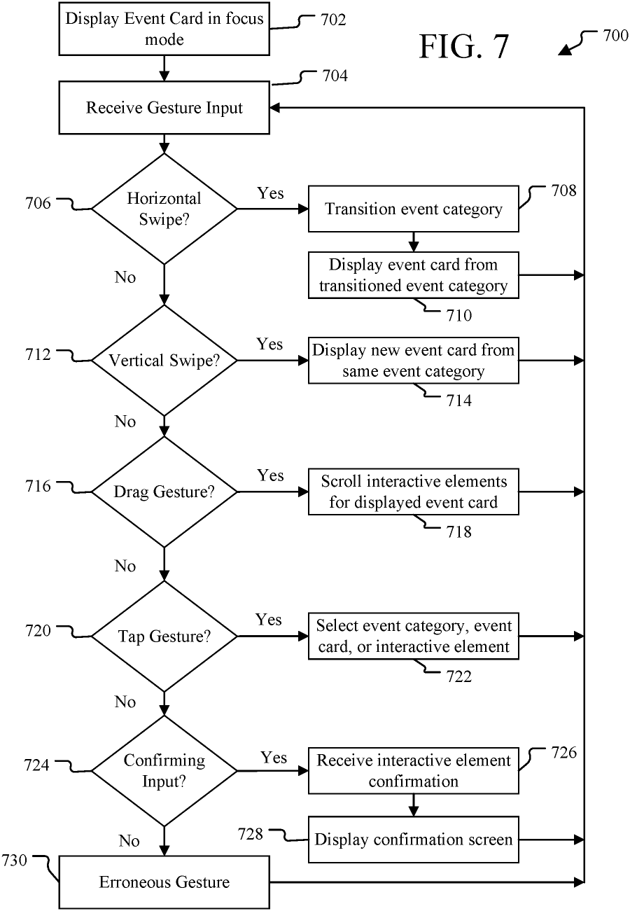

FIG. 7 is a block diagram illustrating a method of providing a focus mode for an application, according to aspects described herein. Flow begins at operation 702 where an event card is displayed in the focus mode. In aspects, the displayed event card may be initially be selected based upon user settings. For example, if the user has a favorite team, an event card for the user’s favorite team may be displayed upon initiation of an application employing a focus mode user interface. Alternatively, the initially displayed event card may be determined based upon application history such that the event card previously displayed upon exiting the application is loaded for display the next time the application is used. In yet another aspect, the event card may be selected via the user navigating to a specific event after initiating the application.

Flow continues to operation 704 where a gesture input is received. For ease of description, the input received at operation 704 is described as a gesture received via a touchscreen interface. However, one of skill in the art will appreciate that the method 700 may be performed regardless of the type of input received. For example, the input may be a speech command, input received via a virtual user interface element (e.g., a button, scrollbar, etc.), input received via a physical interface component (e.g., a watch crown, a keyboard, a mouse), or the like. One of skill in the art will appreciate that this method 700 may be practiced regardless of the type of device executing the method or the type of input the device is operable to receive.

Upon receiving the gesture input, flow continues to decision operation 706. At operation 706, the received gesture input is interpreted to determine whether the gesture was a horizontal swipe. If the gesture was a horizontal swipe, flow branches YES to operation 708. At operation 708, the method transitions between event categories. In examples, a transition between event categories is a transition between different leagues. For example, if the displayed event card is for an NBA game, a transition between event categories may include transitioning to a different sports league (e.g., the NHL, the NFL, the Bundesliga, an e-sports league, etc.) or a different event type such as a concert or theater show. Upon transitioning to the new event category, flow continues to operation 710 where an event card from the new event category is displayed. As discussed above the new event card may be initially be selected based upon application history and one or more user preferences. For example, if the user has a favorite team, an event card for the user’s favorite team may be displayed upon initiation of an application employing a focus mode user interface. Alternatively, the initially displayed event card may be determined based upon application history such that the event card previously displayed upon exiting the application is loaded for display the next time the application is used. In yet another aspect, the event card may be selected via the user navigating to a specific event after initiating the application. In still other aspects, the new event card may be selected based upon a current state of an event, overall interest in an event based upon the number of selected interactive elements for the event based on other users’ selections, or if an event is currently in progress. Flow returns to operation 704 from operation 710 where a new gesture input may be received.

Returning to decision operation 706, if the gesture is not a horizontal swipe, flow branches NO to operation 712 where a determination is made as to whether the gesture was a vertical swipe. If the gesture was a vertical swipe, flow branches YES to operation 714 where a new event card is displayed. Unlike operation 710, where an event card from a new event category is displayed, the event card displayed at operation 714 is from the same event category (e.g., the same league or event category type) as the previously displayed event card. Flow returns to operation 704 from operation 714 where a new gesture input may be received.

Returning to decision operation 712, if the gesture is not a vertical swipe, flow branches NO to operation 716. At operation 716, a determination is made as to whether the gesture was drag gesture. As there may be many different interactive elements for an individual event, not all opportunities may be displayed at once on a devices display. If the gesture is a drag operation, flow branches YES to operation 718 where the event opportunities are for the displayed event card are scrolled in the direction of the drag operation. This causes additional interactive elements for the event to be displayed on the device. Flow returns to operation 704 from operation 718 where a new gesture input may be received.

Returning to operation 716, if the received gesture is not a drag gesture, flow branches No to operation 720. At operation 720, a determination is made as to whether the gesture was a tap gesture. If the gesture is a tap gesture, flow branches YES to operation 722 where the event category, event card, or interactive element is selected and displayed in the focus mode. In some examples, the event category, event card, or interactive element may indicate in some way that it has been selected. This may include a change in font, color, highlighting of the element, an action occurring (e.g., in a betting scenario one or more money values being displayed for the bet), and/or some other indication to the user of the selection. Flow returns to operation 704 from operation 718 where a new gesture input may be received.

Returning to operation 720, if the received gesture is not a tap gesture, flow branches No to operation 724. At operation 724, a determination is made as to whether the gesture was a confirming input gesture. If the gesture is a confirming input gesture, flow branches operation indicates that a user may have selected a specific interactive element. If the confirming input gesture is a tap and hold and/or a rotational input of a rotational element of the device, the flow branches YES to operation 726 where the interactive element is selected and displayed for confirmation. At this point, an interface may be displayed that will allow the user to confirm the action associated with the selected interactive element (e.g., place a bet, purchase an item, buy a ticket, etc.). In some examples, this may involve the display of a confirmation ring, timing icon, or other method of indicating to the user that the interactive element has been selected and confirmed via a tap and hold gesture. In other examples, the confirming input may be a rotational input of a rotational element of a device such as a smart watch which has a rotational element. Upon receiving interactive element confirmation, flow continues to operation 728 where a confirmation screen with a confirmation message is displayed. Flow returns to operation 704 from operation 728 where a new gesture input may be received.

Returning to decision operation 724, if the gesture is not a confirming input (or any of the other previously described gestures), then flow progresses to operation 730 where the system identifies the received input as a likely erroneous gesture. As such, the input may be disregarded, and flow returns to operation 704 where a new gesture input may be received.

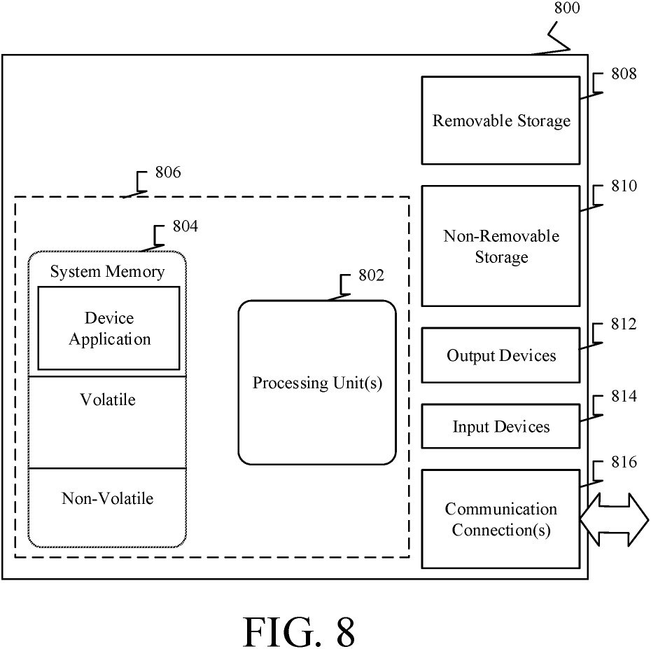

FIG. 8 illustrates a simplified block diagram of a device with which aspects of the present disclosure may be practiced, according to aspects described herein. The device may be a mobile computing device, for example. One or more of the present embodiments may be implemented in an operating environment 800. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, wearable devices such as smartwatches, virtual reality devices, network PCs, minicomputers, mainframe computers, distributed computing environments that include any of the above systems or devices, and the like.

In its most basic configuration, the operating environment 800 typically includes at least one processing unit 802 and memory 804. Depending on the exact configuration and type of computing device, memory 804 (instructions to perform for performing the aspects disclosed herein) may be volatile (such as RAM), non-volatile (such as ROM, flash memory, etc.), or some combination of the two. This most basic configuration is illustrated in FIG. 8 by dashed line 806. Further, the operating environment 800 may also include storage devices (removable, 808, and/or non-removable, 810) including, but not limited to, magnetic or optical disks or tape. Similarly, the operating environment 800 may also have input device(s) 814 such as remote controller, keyboard, mouse, pen, voice input, on-board sensors, etc. and/or output device(s) 812 such as a display, speakers, printer, motors, etc. Also included in the environment may be one or more communication connections, 816, such as LAN, WAN, a near-field communications network, a cellular broadband network, point to point, etc.

Operating environment 800 typically includes at least some form of computer readable media. Computer readable media can be any available media that can be accessed by the at least one processing unit 802 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 800 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

According to an embodiment of the present disclosure, a system is disclosed comprising at least one processor, and memory storing instructions that, when executed by the at least one processor, cause the system to perform a set of operations, the set of operations comprising establish a secure connection between a device an application and a server, receive a selection of a focus mode for the application, determine an event card to display in focus mode based on one or more of an application history and one or more user preferences, display the event card with all available interactive elements for the event on the event card, receive a gesture input, modify the displayed event card based on the received gesture input, select an interactive element and a bet amount on the displayed event card via a tap of the interactive element, receive bet confirmation of the interactive element via a confirming input, and display an acknowledgement of the received bet.

In various embodiments of the disclosure, the gesture input further comprising a horizontal swipe.

In various embodiments of the disclosure, modify the displayed event card further comprising transition to a different event card category, and display a new event card from the different event card category.

In various embodiments of the disclosure, the gesture input further comprising a vertical swipe.

In various embodiments of the disclosure, modify the displayed event card further comprising display a new event card from the same event card category as the currently displayed event card.

In various embodiments of the disclosure, the gesture input further comprising a drag gesture.

In various embodiments of the disclosure, modify the displayed event card further comprising scroll interactive elements for the displayed event card.

In various embodiments of the disclosure, the interactive element includes standardized bet amounts based on one or more of a user history, user preferences, and a user risk profile.

In various embodiments of the disclosure, a confirming input is one or more of a tap and hold gesture or a rotational input of a rotational element of the device.

According to an embodiment of the present disclosure, a method is disclosed comprising establishing a secure connection between a device having an application and an event server, receiving a selection of a focus mode for the application, determining an event card to display in focus mode based on one or more of an application history and one or more user preferences, displaying the event card with all available interactive elements for the event on the event card, receiving a gesture input, modifying the displayed event card based on the received gesture input, selecting an interactive element and a bet amount on the displayed event card via a tap of the interactive element, receiving bet confirmation of the interactive element via a confirming input, and displaying an acknowledgement of the received bet.

In various embodiments of the disclosure, the gesture input further comprising a horizontal swipe.

In various embodiments of the disclosure, modify the displayed event card further comprising transition to a different event card category, and display a new event card from the different event card category.

In various embodiments of the disclosure, the gesture input further comprising a vertical swipe.

In various embodiments of the disclosure, modify the displayed event card further comprising display a new event card from the same event card category as the currently displayed event card.

In various embodiments of the disclosure, the gesture input further comprising a tap and drag gesture.

In various embodiments of the disclosure, modify the displayed event card further comprising scroll interactive elements for the displayed event card.

In various embodiments of the disclosure, the interactive element includes standardized bet amounts based on one or more of a user history, user preferences, and a user risk profile.

In various embodiments of the disclosure, a confirming input is one or more of a tap and hold gesture or a rotational input of a rotational element of the device.

According to an embodiment of the present disclosure, a computer storage media is disclosed including instructions, which when executed by a processor, cause the processor to receive a selection of a focus mode for the application, determine an event card to display in focus mode based on one or more of an application history and one or more user preferences, display the event card with all available interactive elements for the event on the event card, receive a gesture input, modify the displayed event card based on the received gesture input, select an interactive element and a bet amount on the displayed event card via a tap of the interactive element, receive bet confirmation of the interactive element via a confirming input, and display an acknowledgement of the received bet.

In various embodiments of the disclosure, the interactive element includes standardized bet amounts based on one or more of a user history, user preferences, and a user risk profile.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
establish a secure connection between a device an application and a server;
receive a selection of a focus mode for the application;
determine an event card to display in focus mode based on one or more of an application history and one or more user preferences;
display the event card with all available interactive elements for the event on the event card;
receive a gesture input;
modify the displayed event card based on the received gesture input;
select an interactive element and a bet amount on the displayed event card via a tap of the interactive element;
receive bet confirmation of the interactive element via a confirming input; and
display an acknowledgement of the received bet.

2. The system of claim 1, wherein the gesture input further comprising a horizontal swipe.

3. The system of claim 2, wherein modify the displayed event card further comprising:
transition to a different event card category; and
display a new event card from the different event card category.

4. The system of claim 1, wherein the gesture input further comprising a vertical swipe.

5. The system of claim 4, wherein modify the displayed event card further comprising:
display a new event card from the same event card category as the currently displayed event card.

6. The system of claim 1, wherein the gesture input further comprising a drag gesture.

7. The system of claim 6, wherein modify the displayed event card further comprising:
scroll interactive elements for the displayed event card.

8. The system of claim 1, wherein the interactive element includes standardized bet amounts based on one or more of a user history, user preferences, and a user risk profile.

9. The system of claim 1, wherein a confirming input is one or more of a tap and hold gesture or a rotational input of a rotational element of the device.

10. A method comprising:
establishing a secure connection between a device having an application and an event server;
receiving a selection of a focus mode for the application;
determining an event card to display in focus mode based on one or more of an application history and one or more user preferences;
displaying the event card with all available interactive elements for the event on the event card;
receiving a gesture input;
modifying the displayed event card based on the received gesture input;
selecting an interactive element and a bet amount on the displayed event card via a tap of the interactive element;
receiving bet confirmation of the interactive element via a confirming input; and
displaying an acknowledgement of the received bet.

11. The method of claim 10, wherein the gesture input further comprising a horizontal swipe.

12. The method of claim 11, wherein modify the displayed event card further comprising:
transition to a different event card category; and
display a new event card from the different event card category.

13. The method of claim 10, wherein the gesture input further comprising a vertical swipe.

14. The method of claim 13, wherein modify the displayed event card further comprising:
display a new event card from the same event card category as the currently displayed event card.

15. The method of claim 10, wherein the gesture input further comprising a tap and drag gesture.

16. The method of claim 15, wherein modify the displayed event card further comprising:
scroll interactive elements for the displayed event card.

17. The method of claim 10, wherein the interactive element includes standardized bet amounts based on one or more of a user history, user preferences, and a user risk profile.

18. The method of claim 10, wherein a confirming input is one or more of a tap and hold gesture or a rotational input of a rotational element of the device.

19. A computer storage media including instructions, which when executed by a processor, cause the processor to:
receive a selection of a focus mode for the application;
determine an event card to display in focus mode based on one or more of an application history and one or more user preferences;
display the event card with all available interactive elements for the event on the event card;
receive a gesture input;
modify the displayed event card based on the received gesture input;
select an interactive element and a bet amount on the displayed event card via a tap of the interactive element;
receive bet confirmation of the interactive element via a confirming input; and
display an acknowledgement of the received bet.

20. The computer storage media of claim 19, wherein the interactive element includes standardized bet amounts based on one or more of a user history, user preferences, and a user risk profile.
